(19) United States
(12) Patent Application Publication
(10) Pub. No.: US 2023/0337845 A1
(43) Pub. Date: Oct. 26, 2023

(54) AUTOMATED BEACON DELIVERY AND/OR LOCATION ASSISTANCE AND NOTIFICATION SYSTEM

(71) Applicants: Aeron Lydell Glover, Memphis, TN (US); Amber Victoria Glover, Memphis, TN (US)

(72) Inventors: Aeron Lydell Glover, Memphis, TN (US); Amber Victoria Glover, Memphis, TN (US)

(21) Appl. No.: 18/142,588

(22) Filed: May 3, 2023

Related U.S. Application Data
(63) Continuation-in-part of application No. PCT/US23/19499, filed on Apr. 21, 2023.
(60) Provisional application No. 63/333,125, filed on Apr. 21, 2022.

(51) Int. Cl. A47G 29/122; G08B 5/22

(52) U.S. Cl. CPC A47G 29/1225; G08B 5/224

(57) ABSTRACT

Disclosed herein is an automated system to provide delivery persons a simpler manner of recognizing the exact location of a target destination. Such a system includes the utilization of an illuminating device, whether for direct signal viewing or for projection of an indicating signal, provided on a mailbox or other structure placed roadside near or adjacent to, at least, a home or like edifice. The illuminating device may be solar-powered to provide an efficient manner of providing sufficient electricity to generate the necessary illumination result (or projection thereof). The system thus allows for integration of such an illuminating device within an overall process wherein a delivery person (or even a visitor, for that matter) may utilize a GPS or like app as a guide to the desired location with the illumination thereof upon entry within a certain zone proximate to the target edifice for more reliable delivery results.

### CROSS-REFERENCE TO RELATED APPLICATIONS

This application is a Continuation-in-Part of co-pending Patent Cooperation Treaty Application PCT/US23/19,499, filed on Apr. 21, 2023, which claims priority to expired U.S. Provisional Patent Application No. 63/333,125, filed on Apr. 21, 2022, the entirety of both applications being herein incorporated by reference.

### FIELD OF THE DISCLOSURE

Disclosed herein is a manual or automated system to provide delivery persons or travelers a simpler manner of recognizing the exact location of a target destination. Such a system includes the utilization of an illuminating device, whether for direct signal viewing or for projection of an indicating signal, provided on a mailbox or other structure placed roadside near or adjacent to, at least, a home or like edifice (including, without limitation, apartment buildings, strip malls, office buildings, and the like). The illuminating device may be powered in any manner, including, without limitation, solar, battery, AC, etc., to provide an efficient manner of providing sufficient electricity to generate the necessary illumination result (or projection thereof). The system thus allows for integration of such an illuminating device within an overall process wherein a delivery person (or even a visitor, for that matter) may utilize a GPS or like app as a guide to the desired location with the illumination thereof upon entry within a certain zone proximate to the target edifice for more reliable delivery results.

### BACKGROUND OF THE PRIOR ART

The advent of satellite-based mapping, and thus automated travel directions through a mounted computer-based device or, nowadays, smartphones, and the like, has seemingly provided the best manner of routing for travelers and delivery persons alike. However, even with such sophisticated technology, there remain certain difficulties, particularly as it concerns the actual location of the user's ultimate destination. Mapping technology seems to be rather limited as it relates to such final destinations as many can attest to the routing provided merely states “you have reached your destination” without any definitive indication other than a statement provided within the computerized/satellite system. In other words, if the actual destination does not provide a well-defined indicator (clear address numbers, for instance), the user may still necessarily rely upon further inquiries (getting out of one's vehicle for a close-up inspection, for example) rather than simply depending upon the mapping device alone. Such issues may be compounded if such traveling/delivering occurs after sundown due to difficulties in recognition of address indicators in low light. Additionally, certain deliveries may be made to apartments, office parks, warehouses, or even strip malls (or like structures) where addresses are delineated by floors, suites, rooms, or other like partitions. A mapping device may be able to provide a general location with such grouped offices but pinpointing the definitive place may be difficult and require more effort on the part of the user.

Furthermore, mail deliveries are commonplace as of today, with companies such as, without limitation, Amazon, UPS, Federal Express, and the United States Postal Service all seeking correct locations and destinations for packages, letter, and other parcels. Food deliveries have gained interest as well, with companies such as Uber Eats, GrubHub, Shipt, InstaCart, etc., providing such services (not to mention well-known pizza delivery companies such as Dominos, Papa Johns, Marco's, and the like). Many times the system used by the delivery person steers her to an incorrect location, creating a problem for the person receiving (or supposed to be receiving) such packages, etc.; hunting down a misdelivered package is not uncommon as a result, sometimes leading to a lost package, etc., and the sender and receiver both left in a bind. There have further been problems associated with food delivery (a rather notable topic in today's pandemic-based climate) in that the delivery person arrives at the wrong house, delaying such delivery to his detriment. Of course, the potential problems associated with finding the correct location (e.g., having trouble with such a search) may lead to delayed delivery, as well. The need to ensure accuracy in such instances can mean a rather important distinction between a suitable, fresh delivery and a problematic, cold result. The more concise a delivery location, in other words, could mean a huge difference with an improved accuracy in terms of definitive delivery of even a few minutes.

Additionally, the casual visitor to a person's home (or office, etc.) may utilize such mapping technologies as noted above to travel to such a destination, as well. Even with a full mapped-out route, there is always the potential for mistakenly ending at the wrong location or, as above, the user having to further search for the actual address to determine the exact destination even with a route provided in such a manner. There have been instances where a visitor has ended up at the wrong home, leading to disastrous consequences. As it is, the ability to best ensure accuracy of location for a traveler/user in such situations is paramount. Additionally, however, the lack of definitive confirmations of exact locations as intended for either a delivery person or casual visitor may necessitate a more robust system and/or method to ensure arrival at the precise destination sought. Currently, even if a user inputs what is thought to be the desired address as a destination within a smartphone, GPS, or the like, such may be mistakenly entered in such a manner and the user may be directed to the wrong location as a result. For instance, if an address in a city or town includes the same number and street name, but somehow is labeled differently from the correct address (i.e., 100 1st Street instead of 100 1^{st} Avenue), although the user is apparently directed to the right address, in actuality, the opposite is true. Thus, a system wherein the user and the expected destination address are matched for proper location (and illuminated properly upon arrival) would be extremely beneficial within this industry. To date, however, such attractive improvements are unfortunately nonexistent.

As such, there exists a need to provide a more accurate means of alerting a delivery person/traveling visitor to the specific address destination from his or her vehicle, particularly while utilizing the benefits of GPS technology (again, whether vehicle-mounted or smartphone-provided, and the like). To date, other than such base GPS programs (and thus devices), the reliance upon the routing technology provided, and thus the mapping results, coupled with computerized voice technology for spoken direction, is where such program benefits end. There remains a necessary improvement to best guide a traveler (delivery person or visitor, etc.) to a desired location with an external indicator unique to the destination itself and that activates in relation to such a routing program when utilized in such a manner. The ability to do so once the target traveler is within a certain distance thereof would further be of importance, potentially to provide not only the traveler with a pinpoint location indicator, but the person receiving the same with an indicator of the presence of the traveler (delivery person, etc.) at a specific time as well. To date, again, nothing has been provided in this manner within the GPS/mapping technology industries.

Advantages and Summary of the Disclosure

One particular advantage of the disclosure is the ability to provide an automated manner of indicating a location through coupling an app/GPS system with a receiver at a specific location in relation to a map/GPS routing program. Another advantage of the disclosure is the versatile placement of such a location receiver at a residence or building with a further coupled activation switch associated therewith to provider an outwardly visible indicator. Yet another advantage of the disclosure is the ability to utilize an easily activated/deactivated LED indicator in relation to a receiver (such as, for example, an RFID from a Bluetooth transmitter of a phone or GPS system). The ability to further utilize a manual switch capability (such as through a remote or wired switch) for such an LED indicator is another advantage for a traveler/deliverer to locate such a home or building. Additionally, the ability to incorporate a projector in association with a receiver or manual switch to project a message for a traveler/courier is another advantage of the disclosure. Still another advantage within this disclosure is the ability to synch a delivery person/traveler with a customer/acquaintance with regard to such an individualized trip to the customer/acquaintance's location through an app system via Bluetooth advertising packets in relation to an initial communication from traveler/delivery person to the acquaintance/customer.

Accordingly, this disclosure encompasses a method of providing indication of a specific location in relation to a map routing program for a user thereof, said method comprising the steps of: i) providing an indicator selected from an illuminating/emitting light source and a projecting source placed on a mailbox or edifice associated with a specific address location; ii) correlating said indicator to a wireless communication system (such as Bluetooth, radio frequency identifications, or a like system) on a smartphone or GPS system, wherein said wireless communication system wirelessly transfers signals from said smartphone or GPS system during utilization of said map routing program thereon until received by said indicator; and iii) upon receipt of said signals from said smartphone or GPS system, said indicator activates to provide identification of said specific address location thereof. Further encompassed herein is an indicator device comprising an illuminating/emitting light source or a projecting source and including a RFID, or like technology, component for receipt of signals from a smartphone or GPS mapping program and further including an operating switch associated with receipt of signals through said RFID component that activates such an illuminating/emitting light source or projecting source, wherein said indicator device is housed on a mailbox or on an edifice. A saddle structure over a rounded mailbox may be one form of the illuminating/emitting device of the disclosure. A projecting device may be incorporated within the underside, as one non-limiting example, of a mailbox to provide a projected message or simple outward indication of proper location to a mapping program user, as well. Such a projector may thus provide a downward emission of a beacon on the street in front of the mailbox (again, as one non-limiting example) including, for instance, the location address, a statement of “HERE” or “YOU ARE HERE” (or anything similar thereto), basically an indicator that provides a lighted presentation that shows arrival (or close proximity thereto) by the traveler/courier to the address. Thus, in terms of such a location beacon, any type of device that may be attached, connected, or otherwise incorporated/integrated with a mailbox (whether present by the side of a road or street associated with such an address location or on a mailbox attached to an edifice), a home, an office building, and the like, basically any type of structure that provides a suitable means for indication of a specific address location for a mapping program user, may be utilized in such a manner. A “smart” mailbox, for example, may be provided with the typical structure (enclosed cavity with an opening/closing door to protect any mail delivered and placed therein) and illuminating/emitting/projecting component(s) integrated on or within the mailbox to activate in relation to the automated signal reception of the appropriate component of the mailbox for such a purpose.

Such an illuminating light source may be, as one non-limiting, but potentially preferred embodiment, a light emitting diode device that activates automatically in association with the above-noted RFID receiver. Such a device may be manually activated, if desired, not to mention if the automatic switch capability is compromised at any time in some manner, as well. A remote activating device may be operated for such a purpose by a person at the indicator location address, for example. With an electrical connection provided to a certain electrical source (such as at a home or other type of edifice), such may be operated with a switch located within or outside such a home or edifice, as well.

The same may be undertaken with a projector device to activate automatically or manually, as needed or desired. A projector may be of a very small size and structure in this manner with an expanding projection of a message or other type of indication for a mapping program user to view upon placement within a sufficiently close proximity thereto. In essence, the presence of provision of such a device to generate a clear indication of a target address location associated with a mapping program is disclosed for such a purpose.

The general concept to be followed herein utilizes such a system associated with a mapping program (again, through a smartphone or GPS device) wherein such a mapping program source comprises and utilizes RFID emitter potential (through, again, a Bluetooth chip within the smartphone or GPS device, for instance) to transfer signals to a specific RFID receiver associated with the address specifically targeted with the mapping program. In such a manner, the mapping program user would rely upon such RFID emitter potential to the maximum distance permitted, typically up to 350 feet, from the RFID receiver. Thus, the automated viability of such an overall system provides a mapping program user with close proximity location capabilities beyond the mapping program itself, but the outward indication capability of such illuminating/emitting light sources or projector devices associated with and activated in relation to RFID receiving of such signals from the mapping program device. In other words, a mapping program user (traveler, courier, etc.) will have not only the mapping program itself as the destination indicator, but, for total indication capability, the illuminating/emitting/projecting sources are further beacons for definitive address location capabilities. With the distance maximum for such definitive address locating purposes, the actual time required for such illumination/projection, etc., would be relatively short, thus limiting the amount of energy required for such operating times. Once a mapping program user (again, traveler/courier, etc.) arrives and locates the definitive address in such a manner, deactivation of the mapping program may then discontinue the RFID signal(s) and the illuminating/projecting, etc., device may then deactivate, as well. Thus, within a certain distance/radius of an inputted location, the mapping program (app, as one non-limiting example) emits a signal to a receiver (RFID) on the location address mailbox or building and activates the light/projector source to indicate the proximity and definite sought-after location of the mapping program user, providing reliable results in such a manner. A traveler can be assured the location is correct, particularly if an address is not easily found on a mailbox or edifice and the mapping program provides ambiguity as to the route end, as well.

Such an illuminating/emitting light source and/or projecting source may be provided with, as alluded to above, a dedicated electrical connection and source from the home or edifice. Alternatively, and potentially preferred, an embodiment utilizing solar power with energy storage continuously for such a purpose may be followed instead. Due to the rather limited times required for such illuminating/emitting/projecting operation of the beacon device itself (again, since a mapping program user will view such a beacon within a limited distance/radius of 350 feet maximum), the solar-powered alternative is particularly attractive in this respect.

Such an indicator device may thus provide a certain light (color or otherwise), a lighted array (with actual street number, for instance), projected words (HERE, for instance), as well as, particularly with LED capabilities, an ability to adjust light colors and designs for any purpose (holiday themes/colors, sports team colors/logos, family names, etc., myriad applications are available in this context, certainly). A small module may thus be provided over any such light illuminating or emitting source, as well as a projector device, that may clamp (or otherwise attach) to a mailbox surface, building surface, etc. for such a purpose.

The coupling of the location beacon with the mapping program system allows greater reliability, speed, and precision for address locating activities for any type of traveler/delivery courier, etc. Again, as noted above, the potential for mistaken deliveries abounds. The ability to assure a courier for such businesses as popular delivery app services like Uber Eats, GrubHub, Yelp, Shipt, InstaCart, UPS, FedEx, USPS, Amazon, and the like, without limitation, of completely correct address locations, would create a significant benefit, certainly. In such a manner, there is a potential for completely programmed delivery systems that utilize a mapping route program for each delivery that upon arrival within the necessary proximity for signal transfer and receipt by the indicator beacon device, the courier may easily view the exact location associated with each package for, again, exact location addresses (and expected flawless delivery results). In other words, with each package, etc., in a delivery route, the courier (for parcels, food, etc.) may enter the next address into the mapping program, or, alternatively, the system may be already programmed to provide updated signals from a Bluetooth, or like, transmitter as the specific address is inputted/sent for the next receiver at the target location device to activate upon signal reception. The courier may also scan each address (or a QR or like symbol, for instance) on the next parcel (or other item) with the updated information for such automated signal transmission to occur for location beacon device reception. Such an overall delivery system in this manner utilizing the potential signal transfer/receipt of the disclosed device and method is also encompassed herein, as well.

Such a delivery system may utilize unmanned automated vehicles in addition to cars and vans, etc., driven by individual persons. In such situations, as examples, drones and robotic devices may be utilized for such a delivery operation. In such a situation, the system may not necessarily require the illumination component as described above, but such an activity may be followed in order for the drone or robot to identify the destination similarly to the manner undertaken by an individual delivery person. Potentially more importantly, as it concerns the capability of the system and devices described herein, the drone or robotic delivery device may communicate (send) a code to the customer involved when delivery commences and, upon acceptance by the customer, once arrival occurs, the code allows for the customer full notification that the delivery is soon to be, or has been, completed at the specified destination. In this manner, again, the ability to precisely allow for delivery to occur through such unmanned automated devices, but the customer is provided full notification of the delivery from start to finish to best ensure pick up at the target destination. As such, the ability to best synchronize the system with the delivery devices and the target customer to best guarantee delivery as well as prevention of, potentially, at least, “porch pirating” since the package, etc., may be presented by the unmanned delivery device easily and within a time frame for the customer to be ready for receipt within a certain range of times. Additionally, such a system may permit the customer with a means to communicate with the unmanned delivery device in such a way as to select a suitable time, as well as be provided an estimated time of delivery (as well as, potentially, again, at least, the estimated time required for such a delivery to be actually delivered, such as, for instance, an indication that the unmanned delivery device will require between 30 to 35 minutes to complete such a mission from the time of departure) for the full operation to be completed. Certainly, a drone may be limited to certain weights of packages, etc., to be delivered whereas a robotic device may transport far heavier types. A flying drone may thus provide such a delivery more quickly than a robotic, rolling, device, as well. IN any event, the ability to incorporate such unmanned delivery devices within the overall system and method disclosed herein is an extra benefit allowing for full communication and notification for the customer involved to best ensure delivery in this manner occurs safely and reliably.

Furthermore, such a system may also function well with regards to emergency operations, particularly ambulance, fire, and police services. As such emergency services typically utilize GPS technology to locate a specific place (home, apartment, office, store, etc.), the ability to correlate such an inputted address for quick and reliable location is quite important, of course. Instances of an incorrect police presence at a wrong address have been a problem, and the necessity of finding the correct address for an emergency health situation speaks for itself. The ability to utilize this disclosed system for pinpoint accuracy in such situations would be desirable, certainly. Thus, the incorporation of such an automated location beacon device as disclosed herein within a typical GPS or other app in relation to such emergency services would be possible and, again, highly desirable, for increased reliability and quickness for services of this type. Such a location device may also be manually activated to provide a definitive location for such emergency service providers. Additionally, such a device may be outfitted with an emergency beacon to distinguish from a standard delivery/courier indicator.

Another possible utilization of the disclosed destination beacon system is alluded to above in relation to the potential of a user inputting the wrong address without realizing such a mistake prior to arrival at the wrong location. As noted above, there have been unfortunate results related to mistaken destinations and unexpected consequences due to such incorrect circumstances. As such, the potential for a mistaken address to be inputted within a GPS or smartphone routing system may not be realized until far too late. The system disclosed herein allows for a user reliability that the correct location will be indicated regardless of inputted address. To that end, initially, the destination would require an illuminated device to ensure the correct location is found and identified. If the destination is noted as within the system itself, and no illumination is noticed upon arrival, that may be understood as at least a first indication that the wrong address has been inputted and to check the actual address again. A further capability of this system in this regard pertains to the customer/acquaintance of the delivery person/traveling visitor possessing a device that receives a notification that such a person is on his or her way to the destination itself. The system thus allows for the user to receive a notification that he or she is expected at the location indicated and associated with a specific code associated therewith. If the code is not received and/or the customer/acquaintance does not reply to such a notification, or, certainly, if the wrong person receives the code/notification and alerts the user of such a situation, then it should be evident that the incorrect address has been inputted for location purposes and the need to check and reenter the correct address is needed.

With the incorporation of a Bluetooth system, there is also the potential for the overall system to not only provide the location beacon, but also a notification for the target location owner that the visitor, courier, emergency service provider, etc., has arrived. Thus, with the beacon illumination/emission/projection activated, the arriving person or persons may provide automatically a text from a phone app, as one example, or the mailbox (or other location) beacon may automatically generate a message for the target location owner, as well.

Overall, then, this disclosure allows for a destination beacon system based on proximity-based illumination at a location to best ensure recognition of a precise location for delivery personnel and/or traveling visitors. Such a destination beacon system relies upon synchronization of certain devices through Bluetooth or any suitable radio transmitter/receiver technology to permit exact location, exact notification of arrival for both parties involved (delivery/traveler as one party and customer/visited person as the other party), and disengagement of the illuminating indicator of arrival subsequent thereto.

Such a destination beacon system thus may involve an order of operations such as, without limitation, the following order of operations:

The delivery driver or traveler selects a destination address, the transmitter (a phone or other type of dedicated communication device) retrieves a code assigned to the delivery location (destination) itself and then transmits the code to the illuminating device at the destination. When the delivery driver or traveler is then within a certain range of the destination (and thus the illuminating device), the receiver detects the code from the delivery driver or traveler and activates the illumination operation (with a range of possible activities including, without limitation, simple lighting, pulsating, strobing, brightening and dimming in cycles, flashing, patterns in sequence of lighting of LED bulbs, any combination of such activities, and the like). The illuminating device will inactivate (and turn off any lighted components, in other words) within a certain timeframe acter activation, upon movement of the delivery driver or traveler from the location, upon disengagement of the communication device from the illuminating device, such as a simple notification switch, voice command, or indication on an app by the customer or person visited, as examples. Additionally, such deactivation of the illuminated device may occur in relation to the overall system indicating any of: delivery of the target package or other parcel or letter (or plural packages, etc.), acceptance of any delivered good(s) or other item by the customer within the system, notification of arrival by the delivery person or traveler within the system in relation to proximity within a set radius of the illuminated device through automatic operation or through active agreement (and action taken) by the customer or traveler's acquaintance within the system.

As it concerns the actual hardware of a potential, non-limiting embodiment of this disclosure, an illuminating device provided herein may include: a printed circuit board component, having attached thereto or at least integrated therewith in some manner, a Bluetooth transceiver as well as ultra-efficient LEDs associated therewith such a Bluetooth transceiver (at least one, as more than one may be present) to activate upon receipt of a proper code related to the user and the location destination of the illuminating device); at least one battery (rechargeable lithium-ion, nickel-cadmium, and the like, potentially preferred); at least one solar panel for continued charging capability upon exposure to sunlight); and an suitable enclosure for the printed circuit board component as described above and the at least one battery, to protect the same from the elements and external environmental conditions to best ensure continuous utilization on demand. The materials themselves should exhibit the ability to withstand long-term outdoor environmental exposures (any type of weather, for instance, over at least 10 years of continuous exposure). Thus, rust-proof metals may be utilized, or polymeric materials that allow for continued sunlight exposure without exhibiting appreciable degradation over such a 10-year minimum time frame. Such materials are well understood by the ordinarily skilled artisan within the mailbox and like industry and thus any such material (for example, without limitation, stainless steel, brass, and like metals, polyolefins, such as polypropylene, polyethylene, polybutylene, and other synthetic polymers, including, again, without limitation, polyacrylates, polycarbonates, polystyrenes, and the like) may be implemented, whether alone or in some type of combination, for such mailbox and other component features of the overall system.

Noted above is not only the potential for incorporating Bluetooth and/or RFID (or other type of wireless communication capabilities for operations thereof) to permit reliable communication between the user's routing system/app and the illuminating device (as well as the customer/acquaintance's communication system/device), but the ability to actually eliminate the full need of a Bluetooth connection for operation of the overall system. Such a Bluetooth capability is thus not required (although it may certainly be utilized, as this alternative is not a necessary format or design of the disclosed system) as an established component therein, but communication may alternatively be undertaken for system and illuminating device operation through transmission of the target destination address code over a Bluetooth advertising packet instead. This possible pathway allows for the code to be sent with other information through the disclosed system and actually saves a couple of seconds in delay between the delivery driver being in range. Furthermore, it is important to also note that the devices may actually ship without any address code. In this manner, the customer may download an app that may then be utilized to upload their address to the system and thus to the illuminating device. Upon correlation by the user (delivery person/traveler) through request for delivery/traveling help in destination location through the system, the customer/acquaintance may then use the app to provide the address and the system is then primed for the delivery person/traveler to arrive within a set radius (or range) of the illuminating device for beacon purposes. Additionally, if desired, the system may include an illuminating component within a residence or building to contemporaneously activate upon illumination of the exterior device in order to provide the customer/acquaintance (as a broad definition of the person or business being delivered to or visited) a similar means of notification for the delivery person/visitor in relation to such a person's proximity thereto.

### BRIEF DESCRIPTIONS OF THE DRAWINGS

FIG. 1 is a depiction of a mailbox-mounted indicator beacon device as one potential embodiment of the disclosure.

FIG. 2 is a depiction of a “smart” mailbox with all indicator beacon device components integrated therein as another potential embodiment of the disclosure.

FIGS. 3, 4, and 5 depict different manners of mounting a location beacon device as potential embodiments of the disclosure.

FIGS. 6 and 7 are depictions of a projector indicator beacon device mounted on a mailbox as another potential embodiment of the disclosure.

FIG. 8 is a flowchart showing a potentially preferred embodiment of operation of the system with illuminating device disclosed herein for destination beacon purposes.

### DETAILED DESCRIPTIONS OF THE DRAWINGS AND PREFERRED EMBODIMENTS

The following descriptions and examples are merely representations of potential embodiments of the present disclosure. The scope of such a disclosure and the breadth thereof in terms of claims following below would be well understood by the ordinarily skilled artisan within this area.

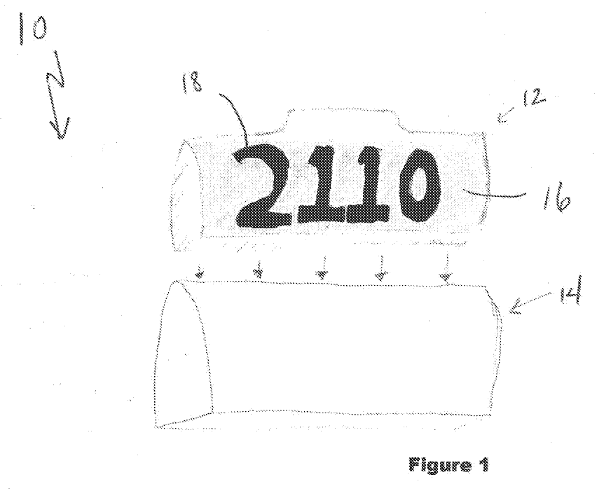

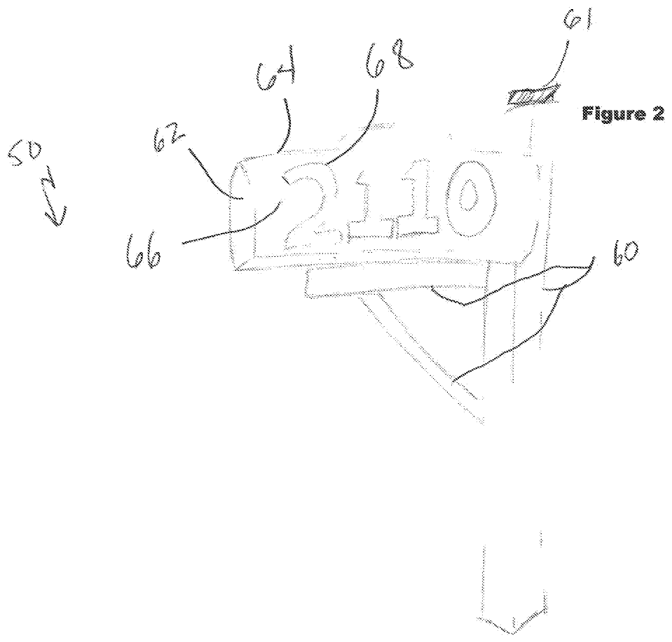

FIG. 1 shows a complete composite 10 of a saddle-shaped device 12 designed to snap/slide/mount/screw on top of a rectangular-dome designed mailbox 14 of any size (Joroleman design). Such a saddle structure 12 may be provided in different sizes to fit various mailbox dimensions, certainly. The saddle 12 thus may be applied/introduced over the top thereof such a mailbox 14 with a connection to a solar-power generator (61 of FIG. 2). The saddle 12, which may be metal, plastic, basically any material that can withstand environmental conditions for long-term usage as well as house or hold the illumination/emitting/projecting components 16 for beacon activation, as well as the electrical components for operation thereof and RFID, etc., components for signal reception safely and reliably (not shown), may be screwed, etc., to the mailbox 14 (such as at the lower sides that generally are supplied with holes for screw fittings. In this manner, with the illuminating/emitting component 16 provided within the saddle structure (in this example with a top extension running parallel to the length of the mailbox itself) with lights (LEDs as an example) provided therein to activate in the manner described above (RFID receiver operates the lights, for instance when a signal is received from a map routing program device). In the exemplified structure, an address 18 automatically lights up in the top extension of the saddle structure 12 when activated. As further described herein, such a presentation for a location beacon provided with a saddle mount of this type, any desired array of lights (for illumination or emission purposes) may be undertaken. Thus, preselected colors, numbers, sports logos, names, messages, and the like, with the potential to adjust/modify such presentations on demand, if desired, is possible, as well. Such a saddle-shaped device 12 may thus be digital in nature and tech-enabled for such displays. The map routing program user (traveler, courier, etc.) may thus rely upon the location beacon in this manner (with numbers/messages/etc.) generated in association with the solar-powered module (or, if desired, or needed, through a dedicated electrical connection or via a remote-control device, as alternatives, particularly if there is a problem or issue with the automated system itself). In this way, then, the map routing program user may enter the target address via the app or GPS system, and, upon arrival at a distance radius of sufficiently close proximity for signal reception by the mailbox mounted device, such a device will display the numbers/message, etc., for identification/clarification of the final destination for the user (courier, traveler, etc.).

FIG. 2 depicts a “smart” mailbox device 64 with a fully completed kit 50 with all the location beacon components fully integrated therein. A mail box base 60 is provided either within the kit 50 or separately for placement of the mailbox 62 and saddle device 64 thereon. In this manner, the device 64 may be made in several different sizes to fit the standard mailbox 62 dimensions, and extra-large dimensions. Extra-large mailbox dimensions with the sides of the saddle are designed to illuminate numbers, letters, and other multimedia determined by the device user. The top of the saddle is designed to fit across the top of the curvature of the mailbox. The fully completed main array of illuminating/emitting lighted components 66 may be arranged/configured in any manner desired on the mailbox itself, as long as the door thereof remains accessible in utilization by a delivery person, of course. Thus, with such integration of components of this type, as above, any type of location address 68 indication/presentation may be permitted (colors, logos, messages, numbers, or any combination thereof). The same integration with a solar-power module 61 may be undertaken as well as for the saddle-mounted device 64 noted above, as well. Likewise, then, a remote control or dedicated electrical switch may be implemented if needed or desired for such address indication purposes, too. The same signal reception at the integrated mailbox device may thus allow for activation of the illuminating/emitting components upon close proximity arrival of a traveler/courier with a signal transferring system (RFID signal, again, for example, through a Bluetooth chip within the map routing program device/system). Again, as described above within this disclosure (and as it applies overall with each automated system described herein), the map routing program utilized by the user (traveler, courier, etc.) includes the specific signal for correlation to the location beacon device on the mailbox (or mounted on an edifice, of course) that is transferred by the Bluetooth (or like) component of the map routing program until the final signal receiver at the target address location device is reached. The indicator activation thus occurs for identification of the definitive address once the user is in close enough proximity thereto. Digital bill-board technology may further be used to display multimedia displays (i.e. holiday-themed or co-branded sports themed lighting solutions, as non-limiting examples) on the mailbox or edifice, as well.

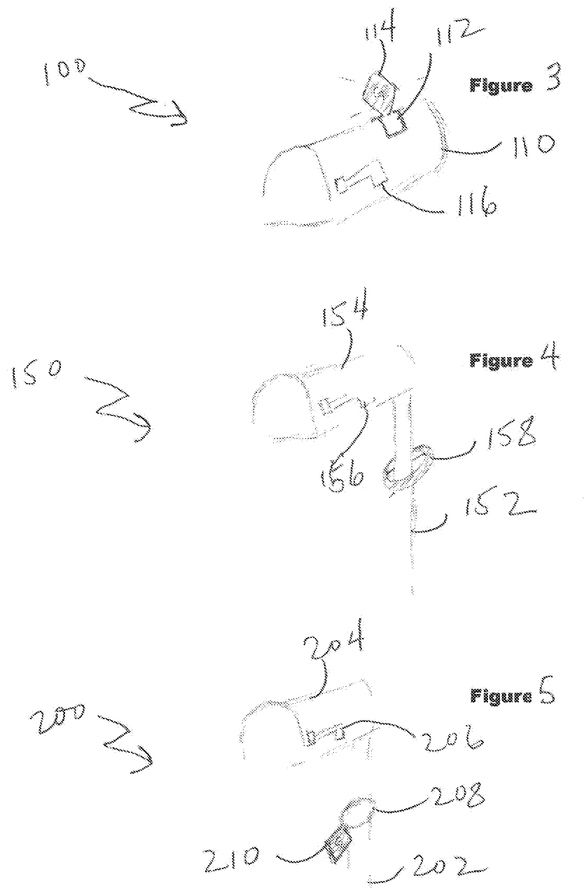

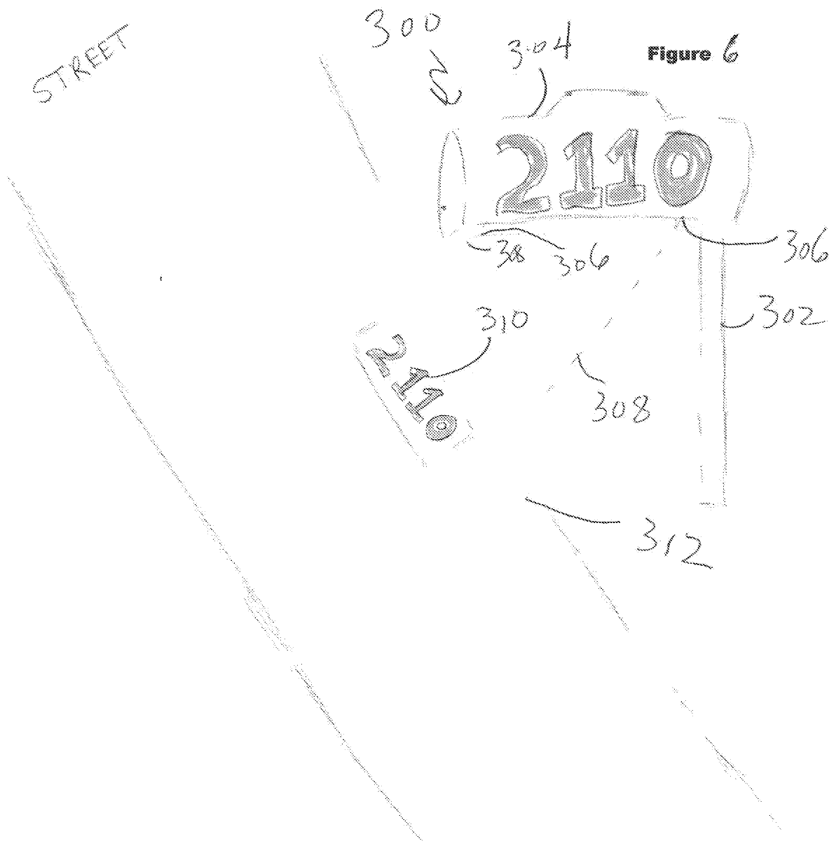

FIGS. 3, 4, and 5 depict different mounted devices on a mailbox. FIG. 3 shows a full indicator/notification illuminated device 100 with a top-mounted structure 112 (here a medallion 114 attached to the dome of the mailbox 110) that includes the light illumination/emission components that activate through reception of a signal as discussed and disclosed herein. The mailbox 110 is not covered in this view and thus includes an exterior “flag” 116 for mail delivery notification if needed, as well. FIG. 4 shows a notification/indicator device 150 including hoop structure 158 around the base mailbox pole 152 for such a purpose (with the same activation and illumination/emission capabilities as above). Such a hoop 158 may be snapped around such a pole 152 for attachment thereto with electrical connections as needed (such as to a solar-powered device, as one possible example) with a mailbox 154 and “flag” 156 provided. FIG. 5 shows a third alternative embodiment overall device 200 with a medallion 210 (such as shown in FIG. 3) that is attached to a mailbox pole 202 via a collar structure 208 (as one non-limiting possible embodiment). As above, the medallion 210 includes the necessary illumination/emission components and is connected to electrical leads for such activation and operation potential associated with a mailbox 204 with “flag” component 206. It should be evident that such examples of potentially preferred embodiments are by means the only types of illuminating devices that may be utilized in such a manner and different arrangements and designs may be implemented as long as the overall beacon and/or location assistance and notification system capabilities are met.

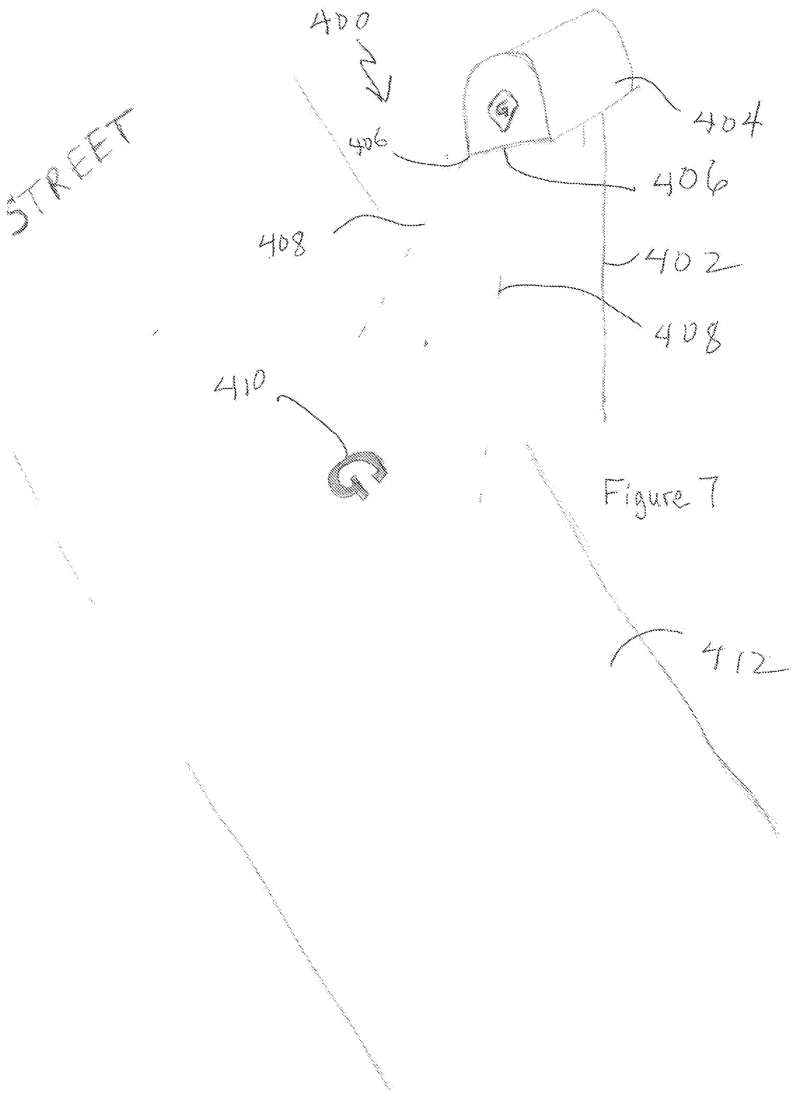

FIGS. 6 and 7 depict an overall mailbox composite 300, 400 including a projector device 306, 406 incorporated into such a disclosed beacon location system that allows for an image 310, 410 to be projected 308, 408 as desired (here, towards the road 312, 412 in front of and below the target mailbox 304, 404). Such a projector 306, 406 may be programmed to provide a message in this manner for facilitating the locating of the residence (in this instance with the mailbox 304, 404) by a visitor, courier, emergency service professional, etc. Such a projector 306, 406 may thus be mounted for image projection purposes underneath the mailbox 304, 404 (pointed downward to the ground/road 312, 412); alternatively, such a projector may be mounted on the mailbox pole 302, 402, on the mailbox 304, 404 top (dome) or other location with possible image generation downward (but possibly on both sides of the target mailbox 304, 404 simultaneously), with a wide projection across the road 312, 412, rather than just downward underneath the mailbox 304, 404 (and thus with a projector 306, 406 having a more panoramic lens for such a wide and deep image), or even to provide a projection backwards towards the actual residence, itself.

Although these Figures show the utilization of the illumination/emission/projection device from a mailbox, it should be well understood, and is disclosed herein above, that this system may also be utilized through the incorporation/attachment of a device to a building. As noted above, the necessity for delivery persons to locate a specific place for effective and reliable delivery is not limited to homes. Office buildings, warehouses, strip malls (with shops/offices, for example), apartments, even duplexes and multiplexes, for that matter, may be provided with an outward beacon to facilitate location by any such delivery person/courier. Apartment buildings may have deliveries made to main offices, of course, but at times deliveries (food, in particular) may be made to specific apartments within a larger complex. The placement of an illuminating/emitting/projecting beacon may be undertaken on the outside of a specific building to provide a courier with greater reliability for outwardly locating the definitive apartment. The same may be said of offices within office parks, as well as a specific warehouse within a larger warehouse park, and a specific suite within a strip mall (or similar structure). As such, a mounted illuminating/emitting/projecting device may also be provided that activates upon receipt of a signal from a route mapping program courier/delivery person, again, as above, when such a person and her program is close enough for the signal (Bluetooth transfer, for example) to be received by the device (RFID, for instance). Such activation thus allows the device to illuminate (or other operation, of course) at such a point in time to provide an outward location beacon to direct the courier/delivery person (or, of course, visitor) to the correct specific destination. With an apartment building, for instance, the general location may be indicated with the possible extra information provided by the beacon as the courier, etc., nears the building itself (if walking to the actual apartment). Such a building-mounted device may be powered as discussed above with solar, etc., components, or integrated within the electrical system thereof, of course. With a projector or LED illumination/emission device, as alluded to herein (and discussed FIG. 4), messages for the courier, etc., may be provided with specific information more easily read as such a person nears the structure. Such a possible edifice-mounted device thus works in the same basic manner as a device associated with a mailbox. The versatility of the disclosed illuminating/emitting/projecting beacon location device, however, allows for any type of extra notification of any person (visitor, courier, emergency service provider, etc.) the ability to clearly and reliably find the specific target address quickly and reliably, regardless of the actual mounted alternative. Such a projector component may be made of standard materials for such applications and devices, as well.

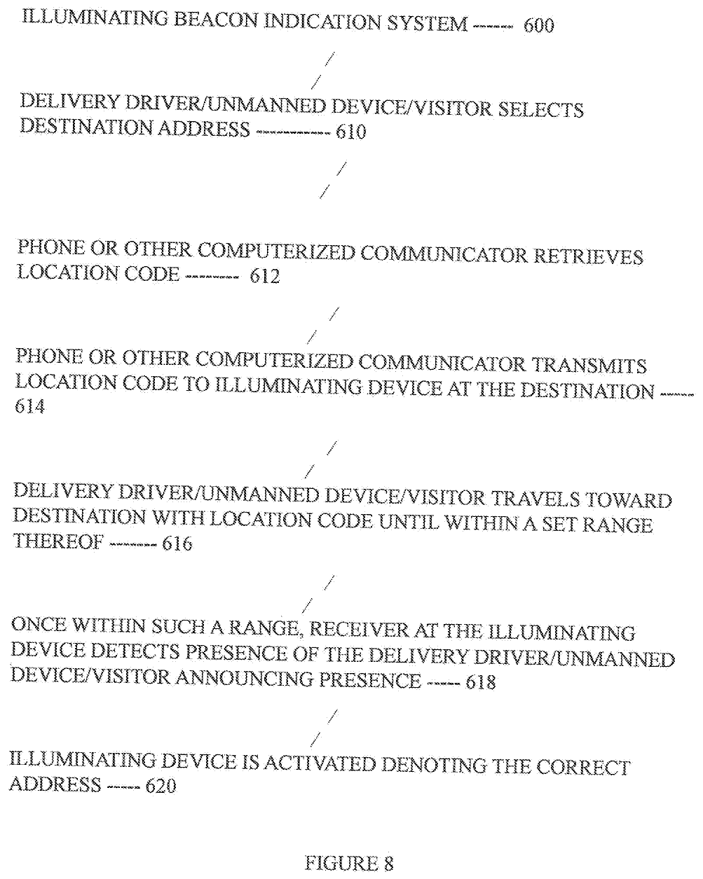

FIG. 8 further shows a flowchart of one possible preferred embodiment of the system 600 with illuminating beacon device described and disclosed herein. Such flowchart steps include the following: the delivery driver or traveler selects a destination address 610, the transmitter (a phone or other type of dedicated communication device) retrieves a code assigned to the delivery location (destination) itself 612 and then transmits the code to the illuminating device at the destination 614. When the delivery driver or traveler is then within a certain range of the destination 616 (and thus the illuminating device), the receiver detects the code from the delivery driver or traveler 618 and activates the illumination operation 620 (with a range of possible activities including, without limitation, simple lighting, pulsating, strobing, brightening and dimming in cycles, flashing, patterns in sequence of lighting of LED bulbs, any combination of such activities, and the like). The illuminating device will inactivate 622 (and turn off any lighted components, in other words) within a certain timeframe after activation, upon movement of the delivery driver or traveler from the location, upon disengagement of the communication device from the illuminating device, such as a simple notification switch, voice command, or indication on an app by the customer or person visited, as examples. Additionally, such deactivation of the illuminated device may occur in relation to the overall system indicating any of: delivery of the target package or other parcel or letter (or plural packages, etc.), acceptance of any delivered good(s) or other item by the customer within the system, notification of arrival by the delivery person or traveler within the system in relation to proximity within a set radius of the illuminated device through automatic operation or through active agreement (and action taken) by the customer or traveler's acquaintance within the system.

Having described the disclosure in detail it is obvious that one skilled in the art will be able to make variations and modifications thereto without departing from the scope of the present invention. Accordingly, the scope of the present disclosure should be determined only by the claims appended hereto.

What we claim is:

1. A method of providing indication of a specific location in relation to a map routing program for a user thereof, said method comprising the steps of: i) providing an indicator selected from an illuminating/emitting light source and a projecting source placed on a mailbox or edifice associated with a specific address location; ii) correlating said indicator to a wireless communicating system on a smartphone or GPS system, wherein said wireless communicating system wirelessly transfers signals from said smartphone or GPS system during utilization of said map routing program thereon until received by said indicator; and iii) upon receipt of said signals from said smartphone or GPS system, said indicator activates to provide identification of said specific address location thereof.

2. An indicator device comprising an illuminating/emitting light source or a projecting source and including a RFID component for receipt of signals from a smartphone or GPS mapping program and further including an operating switch associated with receipt of signals through said RFID component that activates such an illuminating/emitting light source or projecting source, wherein said indicator device is housed on a mailbox or on an edifice.
